(19) United States
(12) Patent Application Publication
(10) Pub. No.: US 2016/0182111 A1
(43) Pub. Date: Jun. 23, 2016

(54) DATA TRANSMISSION SYSTEM AND METHOD JOINTLY USING A TERRESTRIAL LINK AND A SATELLITE LINK

(71) Applicant: THALES, Courbevoie (FR)

(72) Inventors: Marc RATINEY, TOULOUSE (FR); Nicolas VAN WAMBEKE, TOULOUSE (FR); Benjamin GADAT, TOULOUSE (FR)

(21) Appl. No.: 14/975,163

(22) Filed: Dec. 18, 2015

(30) Foreign Application Priority Data
Dec. 23, 2014 (FR) 1402968

(51) Int. Cl. H04B 1/3822; H04W 88/12; H04W 88/16; H04B 7/185; H04W 88/06

(52) U.S. Cl. CPC H04B 1/3822; H04B 7/1851; H04W 88/06; H04W 88/16; H04W 88/12

(57) ABSTRACT

A system for bidirectional data transmission in a telecommunication network comprises at least two distinct access networks to a mobile terminal, comprising at least one hybridation gateway that is configured to constitute an access point to each of the access networks, and to perform at least: control functions for all of the access networks, selection functions for the access network or networks selected for the data transmission, network layer functions, and data link layer functions, and wherein each of the access networks comprises at least one access gateway configured to perform at least physical layer functions.

### CROSS-REFERENCE TO RELATED APPLICATION

This application claims priority to foreign French patent application No. FR 1402968, filed on Dec. 23, 2014, the disclosure of which is incorporated by reference in its entirety.

### FIELD OF THE INVENTION

The invention lies in the field of telecommunications, and more particularly in the field of telecommunication systems dedicated to drone control and command.

It aims to propose a system, and the associated method, allowing for the combined and coordinated use of a satellite link and of a terrestrial wireless link in a telecommunication network, for the bidirectional transmission of data.

The invention describes the architecture of a distributed real-time hybrid station allowing for the implementation of such a system.

### BACKGROUND

The insertion of unmanned aircraft, or drones, into airspace is currently limited to appropriate spaces, called “segregated” spaces, so as to limit the risks of incidents. The segregated spaces are reserved spaces, often military, subject to specific rules, and into which civilian equipment, such as civilian or commercial airline aircraft, do not enter.

The opening up of the non-segregated airspace to drones poses numerous technological problems, such as that of the reliability of the anti-collision mechanisms, or that of the reliability of the telecommunication systems used for control and command. The telecommunication systems used must therefore meet strict criteria in terms of performance (packet error rate, network latency, useful bit rate, overall availability of the system, continuity of the service).

These days, the communication systems from and to a drone more often than not rely on the use of satellite links. This is because this type of link ensures a significant coverage. However, around certain strategic locations, such as, for example, urban areas, or airports, the drone can be in contact with one or more terrestrial stations. The drone can then rely on the terrestrial links in addition to the satellite link.

### SUMMARY OF THE INVENTION

The aim of the invention consists in improving the reliability of the communications by proposing a hybrid telecommunication system relying simultaneously on a terrestrial link and on a satellite link.

The DVB-SH (Digital Video Broadcasting-Satellite Handheld) and DVB-NGH (Digital Video Broadcasting-Next Generation Handheld, the evolution of the DVB-SH standard) standards propose a hybrid satellite/terrestrial data link. In these standards, the hybridation is envisaged at only the physical layer level (layer 1 of the OSI (Open Systems Interconnection) model).

The principle consists in using, on the satellite link and on the terrestrial link, a wave form using an OFDM (Orthogonal Frequency Division Multiplexing) modulation associated with the use of turbo-codes. The transmission takes place over the terrestrial link and the satellite link in such a way that the two signals are received simultaneously by the terminal, and recombined through an MRC (Maximal-Ratio Combining) algorithm, in order to enhance the link budget and therefore the reliability of the link.

The two radio links must therefore be synchronised, the use of an OFDM modulation making it possible to support a limited time offset between the two links.

A first drawback concerning these standards comes from the fact that the OFDM modulations have spectral occupancy and energy consumption properties which are not suited to satellite communications.

A second drawback is that the time offset supported by the OFDM modulation does not make it possible to support excessive mobility variations. The standards are therefore suited to a use to a fixed terminal or one with low mobility, but not to an implementation in a context of high mobility such as aeronautical communications.

Finally, the compatibility with access systems of TDMA (Time Division Multiple Access) or WCDMA (Wideband Code Division Multiple Access) type, which require strong synchronisation between the signals, is problematical.

The European SESAR (Single European Sky Air traffic management Research) programme introduces the notion of “multi-link concept”, in which the link used is selected from the terrestrial link and the satellite link as a function of parameters like the quality of each of the links. However, the links are considered to be independent, the routing or the duplication of the flows being performed in the core network. There is therefore no hybridation of the system as such, which results in the presence of a link setup time upon the switchover from one link to another, which can result in significant latency variations. Furthermore, certain data being transmitted may be lost during this switchover. This mechanism is also presented in the European patent application EP 1 335 530 A1, and in the American patent application US 201 4/01 051 29 A1.

The invention therefore proposes a system suited to communications from and to drones, jointly using a satellite link and a terrestrial link. In this system, the hybridation between the two links is done at the level of the network layer (layer 3 of the OSI model) and of the data link layer (layer 2 of the OSI model), in order to improve the reliability of the data link and guarantee the continuity of the communications.

The invention can also be applied to any type of system that simultaneously has two distinct communication links available.

For this, the present invention describes a gateway intended for the bidirectional transmission of data in a telecommunication network comprising at least two distinct access networks to a mobile terminal. The gateway is characterized in that it is configured to constitute an access point to each of said access networks, and to perform at least:
control functions for all of said access networks,
selection functions for the access network or networks to be used for the data transmission,
network layer functions for said data transmission, and
data link layer functions for said data transmission.

The network layer functions and the data link layer functions for the data transmission are adapted according to the access network or networks selected.

According to one embodiment of the gateway, the control functions for all of the access networks comprise:
the assignment of radio resources to each of said access networks,
control of the radio links of each of said access networks,
control of the signalling of each of said access networks,
control of the mobility of said mobile terminal in the telecommunication network, and
control of the redundancy of the access networks to be used for the data transmission.

According to another embodiment of the gateway, the data link layer functions comprise:
functions of encapsulation of said data,
transmission error control functions on each of said access networks, and
scheduling functions for said data transmissions.

The present invention consists also of a system for bidirectional data transmission in a telecommunication network comprising at least two distinct access networks to a mobile terminal. The system is characterized in that it comprises at least one gateway as defined previously, called a hybridation gateway, and in that each of the access networks comprises at least one access gateway configured to perform at least physical layer functions for said data transmission.

Advantageously, the access gateways of the data transmission system are configured to also perform scheduling functions for the data transmissions.

In one embodiment of the data transmission system, at least one of the access networks is a satellite network.

In another embodiment of the data transmission system, at least one of the access networks is a terrestrial network.

In another embodiment of the data transmission system, the mobile terminal is a drone.

In another embodiment of the data transmission system, at least two of said access networks use different communication standards.

In another embodiment of the data transmission system, the access gateways are configured to provide the hybridation gateway with information concerning the quality of the access networks to which they belong.

Finally, the invention consists of a method for transmitting data to a mobile terminal in a telecommunication network comprising at least two distinct access networks to a mobile terminal, involving a hybridation gateway and at least two distinct access networks each comprising at least one access gateway. The method is characterized in that it comprises at least the steps of:
control, by the hybridation gateway, of all of said access networks, and
selection, by the hybridation gateway, of the access network or networks to be used for the data transmission.

The method further comprises, upon the transmission of data to said mobile terminal, at least the steps of:
implementation, by the hybridation gateway, of the network layer functions on said data to be transmitted, to obtain layer 3 data,
implementation, by the hybridation gateway, of the data link layer functions on the layer 3 data, to obtain layer 2 data packets,
transmission of the layer 2 data packets to said access network or networks to be used, and
implementation, by each of the access gateways of said access network or networks to be used, of the physical layer functions, to obtain layer 1 data packets sent from said access gateways.

Finally, the method comprises, upon the transmission of data from said mobile terminal, at least the steps of:
reception of layer 1 data packets, by each of the access gateways of said access network or networks to be used, and implementation of the physical layer functions, to obtain layer 2 data packets,
transmission of the layer 2 data packets to said hybridation gateway,
implementation, by the hybridation gateway, of the data link layer functions on the layer 2 data packets, to obtain layer 3 data, and
implementation, by the hybridation gateway, of the network layer functions on said data to be transmitted.

The data link layer functions and the network layer functions, implemented by the hybridation gateway upon the transmission of data to or from the mobile terminal, are adapted according to the access network or networks selected in the step of selection of the access network or networks to be used.

According to a variant, at least one of the access networks is a satellite network.

According to another variant, at least one of the access networks is a terrestrial network.

According to another variant, the mobile terminal is a drone.

According to another variant, at least two of said access networks use different communication standards.

### BRIEF DESCRIPTION OF THE DRAWINGS

The invention will be better understood and other features and advantages will become more apparent on reading the following description, given in a non-limiting manner, and through the attached figures in which:

FIG. 1 illustrates a telecommunication network comprising a number of radio links according to the prior art,

FIG. 2 illustrates a first embodiment of a telecommunication network comprising a number of radio links according to the invention,

FIG. 3 illustrates a second embodiment of a telecommunication network comprising a number of radio links according to the invention,

FIG. 4 illustrates an exemplary implementation of the method according to the invention.

### DETAILED DESCRIPTION

The communications of a telecommunication network are generally organised according to the OSI (Open Systems Interconnection) model.

This model describes communications in the form of a layered architecture, each of the layers performing services which are specific to it. The four so-called “upper” layers are the application layers oriented towards specific programs. They handle in particular data coding, synchronisation exchanges, and end-to-end communications between processes.

The three so-called “lower” layers are layers dedicated to the transportation of the data. These are as follows:
Layer 3—Network: this layer is responsible for determining the routing of the data and the logical addressing,
Layer 2—Data Link: also called MAC layer, this layer is responsible for the physical addressing and data segmentation,
Layer 1—Physical: this layer is responsible for the transmission of the data.
Layer 4—Transport forms the link between the upper layers and the lower layers.

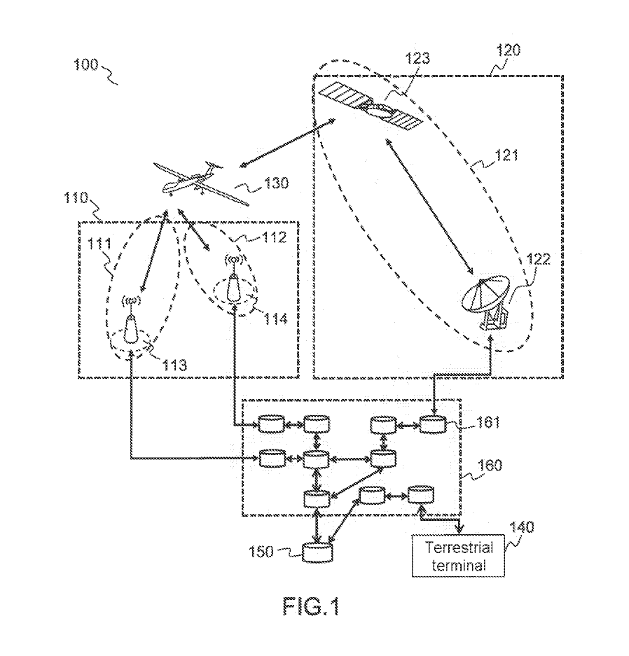

FIG. 1 illustrates a telecommunication network having a plurality of access networks according to the prior art, as defined in the European SESAR programme.

Such a telecommunication network 100 can for example have a terrestrial communication system 110 and a satellite communication system 120. In FIG. 1, the terrestrial communication system comprises two access networks 111 and 112 to an embedded terminal 130, each of the access networks comprising at least one terrestrial access gateway 113 and 114, generally called the base stations. The satellite communication system has, in the example, only a single satellite access network 121 comprising a satellite access gateway 122 and a satellite 123, but could have several thereof. Each of the access networks makes it possible to route messages between a terrestrial terminal 140 and a mobile terminal 130 embedded in an aircraft, where the aircraft can be a drone.

The telecommunication network comprises a gateway called multi-link gateway 150, responsible for supervising each of the communication systems 110 and 120, in order to select the communication system best able to ensure the correct transmission of the data.

All of the gateways communicate via an interconnection network 160. In the case of the SESAR programme, this interconnection network is called EATMN (European Air Traffic Management Network). It interconnects all the ATCC (Air Traffic Control Centre) centres situated in the airports, where the air traffic controllers for the onboard/ground communication systems are located. It consists of a plurality of interconnected routers 161 and, possibly, several interconnected subnetworks.

The interconnection network is therefore a point of entry for the data from the user terminal, and vice versa.

The multi-link gateway 150 is linked to the different communication systems via the interconnection network. In the event of loss of an access network, the routing tables of the interconnection network are updated to take account of the loss of the link to the primary access network and identify a better path between the multi-link gateway and the mobile terminal via the secondary access network.

Each of the communication systems operates independently. In particular, they can use different frequencies, or frequency bands, and different communication standards or wave forms.

Within a same communication system, all of the access gateways take control, through signalling interchanges internal to the system, the functions of resource assignment/release, of mobility management between the different gateways, of choice of bit rates, and all the functions relating to the entry/exit of terminals into and from the system, their mobility, and the trend of the link quality.

The gateways of the different access networks are responsible for performing the processing operations relating to all the lower layers of the OSI model.

Such an implementation presents the following drawbacks in a switchover from a first communication system to a second:
the data currently being transmitted, the unacknowledged data, and the data queued for transmission, particularly in the data link layer processing operations, are lost. These packets must therefore be re-sent, which results in an additional latency, and a non-optimal use of the resources,
the switchover from one access network to the other entails the updating of all the routing tables of the interconnection network and of the wide area networks. Such an updating, on remote sites, entails an implementation time which results in a period of unavailability of the link,
before being able to transmit over the second communication system, a new link must be set up, which introduces an additional latency.

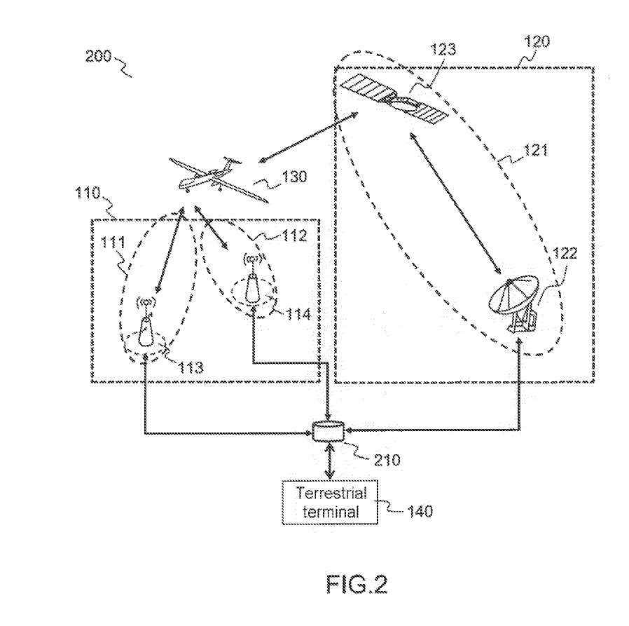

FIG. 2 illustrates a first embodiment of a telecommunication network 200 comprising a number of access networks from and to a mobile terminal 130 according to the invention.

In this embodiment, the different access gateways 113, 114 and 122 are directly linked to a gateway, called hybridation gateway 210.

Contrary to the prior art, the hybridation gateway is directly connected to the different access networks and to the mobile terminal 130. It is a single point of access to each of the access networks, and implements, in real time, the functions traditionally specific to each of these access networks.

The hybridation gateway is linked to each of the access gateways 113, 114 and 121, through point-to-point connections, or IP networks. Each of these links is made by using distinct ports. In this way, the switching from one network to another is done instantaneously from the hybridation station, by switching over the port used to transmit the data. Contrary to the prior art, the switchover does not depend on the convergence of the updating of the routing tables in the IP network. The switchover is instantaneous and does not therefore introduce any latency.

The hybridation gateway 210 performs the hybridation of the different systems at the network layer level and the data link layer level. It is responsible for the control and the management of all of the access networks, the selection of the network or networks to be used for the transmission, the implementation of the network layer functions, and the implementation of the data link layer functions.

The control of the networks comprises the assignment, the release and the reallocation of the resources on each of the communication systems, the monitoring and the analysis of the variations of the quality of each of the access networks, the control of the signalling, including the control of the modulation and coding schemes used, the control of mobility and the control of redundancy.

With the control of mobility being performed in the hybridation gateway, it makes it possible to control the mobility within a communication system (such as, for example the control of intra-cell mobility in a terrestrial communication system or intra-satellite spot mobility in a satellite communication system) but also between the different communication systems (such as, for example, between the terrestrial communication system 110 and the satellite communication system 120).

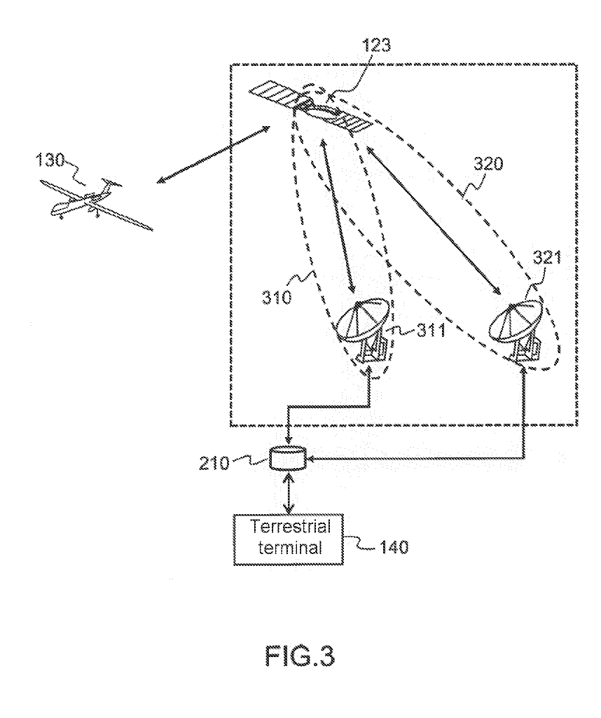

The hybridation gateway is also responsible for the control of redundancy. When the telecommunication network has two networks available that use distinct resources (such as a terrestrial network 111 and a satellite network 121), the packets can be duplicated between the two paths, so as to increase their probability of correct reception, or transmitted by using the two paths, so as to reduce their latency. The control of redundancy applies also to the control of redundant equipment items, described by FIG. 3.

The selection of the network or networks to be used can be done as a function of information concerning the quality of the access networks, through the reporting of QoS (Quality of Service) information, or on the basis of other criteria such as the geographic position of the mobile terminal, the availability of the networks, or the failure of equipment items.

The hybridation gateway also performs the network layer and data link layer functions.

The communication systems 110 and 120 can use different frequencies, frequency bands and communication standards, such as, for example, the DVB-T (Digital Video Broadcasting-Terrestrial) standard for the terrestrial system and the DVB-S (DVB-Satellite) standard for the satellite system.

The network layer functions consist notably in performing the adaptation between the IP network and the data link layer specific to the system (translation of the IP address into a MAC address and translation of the service classes), and are adapted to the communication standards used.

The data link layer functions are also adapted to the communication standard used. They comprise the subdivision and encapsulation of the data into packets adapted to the physical layer, and to the addition of signalling making it possible to reconstruct the data on reception. They also comprise the error control functions, according for example to the ARQ (Automatic Repeat Request) or H-ARQ (Hybrid ARQ) methods, which make it possible to acknowledge the correct reception of the data packets.

The execution of the acknowledgment mechanisms by the hybridation gateway makes it possible, in the case of a switchover from one network to another, to acknowledge, on the new network, the packets (LPDU, Link Layer Packet Data Units) currently being acknowledged on the network previously used. In this way, there are no losses of data, and therefore no retransmissions needed.

Finally, the hybridation gateway performs the data transmission scheduling functions. These functions correspond to the management of the instants of transmission, and the synchronisation of the frames.

The access gateways dedicated to each of the access networks perform the physical layer functions, including the coding, the modulation and the transmission of the packets routed by the hybridation gateway.

When the transit times between the hybridation gateway and the access gateways are not deterministic, or are unknown, the gateways can also implement the transmission instant scheduling functions, relating to the data link layer.

The advantages of the invention are as follows:
the switchover from a first access network to a second access network can be performed instantaneously, regardless of the state of the communication. The invention does not entail any time to update the routing tables making it possible to link the user terminal to the mobile terminal, or time to implement the communication on the new access network,
the invention makes it possible to follow the mobility of the mobile terminal within each of the telecommunication systems, but also between the telecommunication networks, the invention makes it possible to switchover from one access network to another access network by retaining the context of the layers 2 and 3. Upon the switchover from one access network to another, the layer 2 links are not broken and do not have to be re-established, the packets queued or currently being acknowledged are not lost.

The invention therefore makes it possible to improve the availability and the reliability of a communication system, because it makes it possible to be able to switch over from one network to another in a way that is totally transparent to the end user, without modifying the latencies of the network, or loss of packets.

FIG. 3 illustrates a second embodiment of a telecommunication network comprising a number of access networks according to the invention.

In this case, the telecommunication network 300 has two redundant satellite access networks 310 and 320 available, each including a satellite access gateway 311 and 321.

In case of failure of the satellite gateway used, the hybridation gateway 210 can instantaneously switch over to the second gateway without loss of context, or of data. Since the physical resources used (such as the frequency for example) are identical, the switchover is performed transparently for the mobile terminal. This mode of operation is particularly useful for the satellite links, for which the availability of the satellites 123 is low, and therefore particularly affected by the losses of packets and retransmissions.

The second embodiment, illustrated by FIG. 2, and the third embodiment, illustrated by FIG. 3, can be implemented simultaneously in a same telecommunication network.

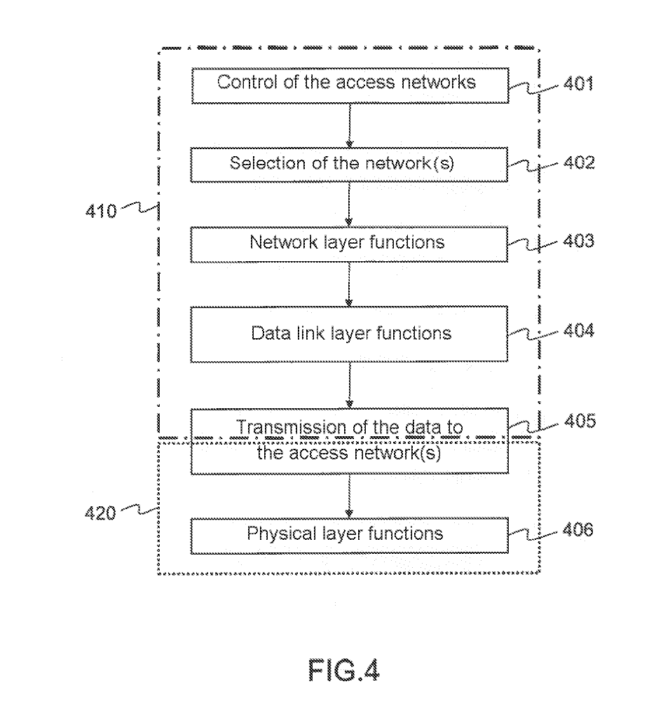

FIG. 4 illustrates an exemplary implementation of the method according to the invention for transmission of data from a user terminal 140 to a mobile terminal 130 in a hybrid telecommunication network comprising a number of distinct access networks to a mobile terminal.

This method is intended to be implemented on real-time computation devices included in a hybridation gateway 210 and in each of the access gateways 113, 114 and 122. These devices can be various hardware and/or software elements, such as computer programmes or dedicated electronic circuits for example.

The method can be executed by a reprogrammable computation machine (a processor or a microcontroller for example) executing a programme comprising a sequence of instructions, or by a dedicated computation machine (for example a set of logic gates such as an FPGA or an ASIC, or any other hardware module).

The method consists in the performance of a first step 401 of control of all of the access networks by the hybridation gateway. As described previously, this control comprises at least the management of the radio resources of each of the communication systems, the supervision of the signalling, and in particular of the quality and availability of the different links, the management of mobility, and the management of redundancy.

A second step 402 of selection of the access network or networks to be used is performed by the hybridation gateway. This step is based on the supervision of the signalling performed in the step 401.

A third step 403 of application of the network layer functions to the data received from a user terminal is performed by the hybridation gateway. This step is adapted according to the communication standards used by the access network or networks selected in the step 402, and makes it possible to convert the data into layer 3 data.

A fourth step 404 of application of the data link layer functions is executed by the hybridation gateway. This step is adapted according to the communication standards used by the access network or networks selected in the step 402, and makes it possible to convert the layer 3 data into layer 2 data packets.

A fifth step 405 of transmission of the layer 2 data packets from the hybridation gateway to the access gateway or gateways selected in the step 402 is performed. This step consists in transmitting the data by the hybridation gateway and in receiving them by the access gateway or gateways. If the link between the hybridation gateway and the access gateway or gateways is an IP link, this step comprises the encapsulation of the layer 2 data packets in IP messages by the hybridation gateway, and the de-encapsulation of the IP messages by the access gateway or gateways.

Finally, a sixth step 406 of application of the physical layer functions is performed by the access gateway or gateways selected in the step 402 on the layer 2 data packets. This step comprises the application of the different physical layer algorithms, such as the error correcting code, interleaving and modulation, and the transmission over the radio link of the layer 1 data packets.

The hybridation gateway is therefore responsible for the execution of the steps 410 comprising the steps 401, 402, 403, 404 and the transmission of the data in the step 405.

The access gateways are therefore responsible for the execution of the steps 420 comprising the reception of the data in step 405, and the step 406.

The implementation of the method, according to the invention, of transmitting data from a mobile terminal 130 to a user terminal 140 repeats the steps 401 and 402 performed by the hybridation gateway, and successively executes the operations mirroring the steps 406, 405, 404 and 403.

1. A gateway for the bidirectional data transmission in a telecommunication network comprising at least two distinct access networks to a mobile terminal, said gateway configured to constitute an access point to each of said access networks, and to perform at least:
control functions for all of said access networks,
selection functions for the access network or networks to be used for the data transmission,
network layer functions for said data transmission, adapted according to the access network or networks selected, and
data link layer functions for said data transmission, adapted according to the access network or networks selected.

2. The gateway according to claim 1, wherein said control functions for all of the access networks comprise:
the assignment of radio resources to each of said access networks,
control of the radio links of each of said access networks,
control of the signalling of each of said access networks,
control of the mobility of said mobile terminal in the telecommunication network, and
control of the redundancy of the access networks to be used for the data transmission.

3. The gateway according to claim 1, wherein said data link layer functions comprise:
functions of encapsulation of said data,
transmission error control functions on each of said access networks, and
scheduling functions for said data transmissions.

4. A system for bidirectional data transmission in a telecommunication network comprising at least two distinct access networks to a mobile terminal, comprising at least one gateway according to claim 1, called a hybridation gateway, and wherein each of the access networks comprises at least one access gateway configured to perform at least physical layer functions for said data transmission.

5. The data transmission system according to claim 4, wherein said access gateways are configured to also perform scheduling functions for the data transmissions.

6. The data transmission system according to claim 4, wherein at least one of the access networks is a satellite network.

7. The data transmission system according to claim 4, wherein at least one of the access networks is a terrestrial network.

8. The data transmission system according to claim 4, wherein said mobile terminal is embedded in a drone.

9. The data transmission system according to claim 4, wherein at least two of said access networks use different communication standards.

10. The data transmission system according to claim 4, wherein said access gateways are configured to provide said hybridation gateway with information concerning the quality of the access networks to which they belong.

11. A method for transmitting data to a mobile terminal in a telecommunication network comprising at least two distinct access networks to a mobile terminal, involving a hybridation gateway and at least two distinct access networks each comprising at least one access gateway, comprising at least the steps of:
control, by the hybridation gateway, of all of said access networks, and
selection, by the hybridation gateway, of the access network or networks to be used for the data transmission, further comprising, upon the transmission of data to said mobile terminal, at least the steps of:
implementation, by the hybridation gateway, of the network layer functions, adapted according to the access network or networks selected, on said data to be transmitted, to obtain layer 3 data,
implementation, by the hybridation gateway, of the data link layer functions, adapted according to the access network or networks selected, on the layer 3 data, to obtain layer 2 data packets,
transmission of the layer 2 data packets to said access network or networks selected, and
implementation, by each of the access gateways of said access network or networks selected, of the physical layer functions, to obtain layer 1 data packets sent from said access gateways,
and comprising, upon the transmission of data from said mobile terminal, at least the steps of:
reception of layer 1 data packets, by each of the access gateways of said access network or networks selected, and implementation of the physical layer functions, to obtain layer 2 data packets,
transmission of the layer 2 data packets to said hybridation gateway,
implementation, by the hybridation gateway, of the data link layer functions, adapted according to the access network or networks selected, on the layer 2 data packets, to obtain layer 3 data, and
implementation, by the hybridation gateway, of the network layer functions, adapted according to the access network or networks selected, on said data to be transmitted.

12. The data transmission method according to claim 11, wherein at least one of the access networks is a satellite network.

13. The data transmission method according to claim 11, wherein at least one of the access networks is a terrestrial network.

14. The data transmission method according to claim 11, wherein said mobile terminal is embedded in a drone.

15. The data transmission method according to claim 11, wherein at least two of said access networks use different communication standards.
